(19) United States
(12) Patent Application Publication
(10) Pub. No.: US 2006/0236672 A1
(43) Pub. Date: Oct. 26, 2006

(54) Gliding rake or rolling broom

(76) Inventor: Thomas F. Duffy, Owego, NY (US)

Correspondence Address: RICHARD L HUFF, 19304 OLNEY MILL ROAD, OLNEY, MD, 20832, US

(21) Appl. No.: 11/110,629

(22) Filed: Apr. 21, 2005

(51) Int. Cl. A01D 7/00

(52) U.S. Cl. 56/400.04

(57) ABSTRACT

A rake having a curved handle and a rake head which is made up of a frame having a crossbar connecting the sides of the frame and connecting to the handle. The rake head contains sidepieces which are so shaped as to enable the rake head to glide across the ground. The sidepieces may fit into ski glides or spoon glides to provide this property. The frame is straight or is arced so as to provide a large area of containment. The invention also presents a broom or squeegee having the same handle as the rake. The handle is connected to an adapter, which fits into either side of a handle connector. The broom or squeegee is also connected to wheels so that it may be moved without being lifted from the surface to be cleaned or dried.

### CROSS-REFERENCE TO RELATED APPLICATIONS

### STATEMENT REGARDING FEDERALLY SPONSORED RESEARCH OR DEVELOPMENT

(Not applicable)

### REFERENCE TO SEQUENTIAL LISTING, A TABLE, OR A COMPUTER PROGRAM LISTING APPENDIX SUBMITTED ON A COMPACT DISC

(Not applicable)

### BACKGROUND OF THE INVENTION

1) Field of the Invention

This invention relates to rakes for gathering leaves or other debris. Also, this invention is directed to implements for cleaning floors, such as push brooms, for cleaning dirt and other debris from floors.

2) Description of the Related Art

Raking leaves is often arduous and time-consuming labor. Heretofore, devices have been developed for reducing the laborious task of hand raking by providing wheeled raking devices.

Power raking machines which utilize a gas or electric motor to drive a reciprocating rake head are shown in U.S. Pat. Nos. 3,777,460 and 3,417,554. These machines are often used for general lawn conditioning purposes such as removing thatch or dead grass from lawns. They require access to an external electrical hookup as well as extended lengths of electrical extension cord. The resulting machines are rather heavy and inconvenient to use for raking loose lawn cover such as leaves. Power machines do not appear to be practical for such purposes.

Manual raking devices have been developed, such as shown in U.S. Pat. Nos. 2,329,708 and 1,020,228, wherein raking tines are supported by wheels. The devices may be rolled along the ground with the raking tines gathering leaves and the like in the path of the device. Such devices do not require an auxiliary power source. However, the raking tines are only moved over the ground and are not provided with a simulated raking action. Leaves can soon accumulate beneath the raking tines resulting in a dragging raking action which will not rake cleanly.

In U.S. Pat. No. 3,824,773, a wheeled power raking device is disclosed having a plurality of individual hand rakes operated by a crankshaft. The crankshaft is powered by an electric motor to move the individual rakes through a raking motion over the ground. Again, the attendant inconveniences and dangers of having an auxiliary power source are necessary and appear to outweigh the practical advantages of such a device, except possibly for commercial application.

The process of using rakes which do not have the above labor-saving additions varies depending on the type of landscape to be cleared. In the raking process in open areas, the user stands upright, lifts the rake, extends it forward and places it on the ground having debris. The user then retracts the rake, pulling back the debris. This sequence is repeated until the ground has been cleared of debris.

In the raking process under low-imbed trees and shrubs, the user bends over and grips the rake so that the rake may be extended off the ground in a low trajectory. The rake is then extended under the limbs before placing it on the ground having debris. The rake is then retracted, pulling the debris with it.

As can readily be appreciated, in spite of the improvements which have been made, raking is still an arduous process. The wheeled rakes are heavy and are not easily turned. The conventional rakes require lifting each time the rake is moved.

Implements for cleaning floors are well known. Such implements are brooms, mops, and squeegees. Common push brooms contain bristles of horsehair, fiberglass, or plastic. These bristles are fastened into generally rectangular bases made of wood or plastic. The bases have two attachment holes for the handles. These holes are placed at complementary angles to allow for even wear of the bristles. Commonly, the holes and the handles are threaded for easy attachment and disengagement. Some type of stabilizing reinforcement mechanism is common in push brooms. A typical prior art push broom is found in U.S. Pat. No. 4,384,383, granted to Bryant May 24, 1983.

The prior art push brooms may be used with a pushing motion to push dirt and other debris away from the user or may be operated with a pulling motion to bring dirt and other debris toward the user. Either mode of use requires the broom to be lifted at the end of one cleaning movement and placed in a new desired position for the next cleaning movement.

### BRIEF SUMMARY OF THE INVENTION

The present invention addresses the problems outlined above and seeks to eliminate them while still maintaining a rake which will clear debris or an implement for cleaning floors. The present invention is directed to a new rake or implement for cleaning floors which allows the user to remain upright under all conditions and which eliminates the step of lifting the rake or implement for cleaning floors each time it is used. The rake or implement for cleaning floors of this invention has a unique handle which allows the user to remain erect while raking or cleaning floors. The handle also allows for easy storage and has a unique handgrip which allows for easy transportL

The rake of one embodiment of the present invention has a bulb-shaped front end joining sloping shoulders for penetration into hard-to-reach areas. This shape increases the debris-contaiunment width and overall containment area. The rake of a second embodiment contains a rake head featuring a single smooth arc. The rake head of a third embodiment features a rake head having a straight frame. The rake head has sidepieces which glide along the ground. The sidepieces may have bottoms which are so shaped to glide along the ground or which fit into skis or spoons which glide along the ground to enable the user to avoid lifting the rake each time the rake is used. The rake of the invention may also have an adjustable handle.

The floor cleaning implement of this invention contains a handle similar to that used with the rake. The preferred embodiment of such an implement is a push broom. The broom base contains conventional bristles, a connection for the handle, and connections for the wheel mechanism. The wheel mechanism may be mounted on either side of the broom base so as to permit even wear of the bristles. The wheel mechanism supports either fixed or swivel wheels so as to allow the broom to be moved to a desired new position without lifting the broom.

As can be readily seen from the above, this invention allows for the accomplishment of the laborious tasks of raking and cleaning floors without the usual steps of lifting and carrying the rake or implement for cleaning floors and setting the rake or implement for cleaning floors in a new position.

### BRIEF DESCRIPTION OF THE SEVERAL VIEWS OF THE DRAWINGS

FIG. 1 is a side elevational view of the rake of this invention in the lowered, or operating, position.

FIG. 2 is a side elevational view of the rake of this invention in the raised, or moving, position

FIG. 3 is a side elevational perspective view of the rake head of one embodiment of this invention.

FIG. 4 is a side elevational perspective view of the rake head of a second, and preferred, embodiment of this invention.

FIG. 5 is a front elevational perspective view of the rake head of FIG. 4.

FIG. 6 is a plan view of the rake head of FIG. 4.

FIG. 7 is a rear sectional view of the rake head of this invention at the point where the handle attaches to the crossbar.

FIG. 8 is a front elevational view of the rake head according to a third embodiment of this invention

FIG. 9 is a side elevational view of the rake head of the third embodiment of third invention.

FIG. 10 is a plan view of the rake head of the third embodiment.

FIG. 11 is a sectional view of a portion of the crossbar showing attachment of the handle to the crossbar.

FIG. 12 shows one alternative of transporting the rake of this invention.

FIG. 13 shows a second alternative of transporting the rake of this invention.

FIG. 14 is a front elevational perspective view showing the mechanism which allows for lengthening and shortening of the handle.

FIG. 15 is a plan view of the rake head and a portion of the handle showing a handgrip on the distal end of the handle.

FIG. 16 is a front view of the handgrip located at the proximal end of the handle.

FIG. 17 is a side view of the handgrip of FIG. 16.

FIG. 18 is an elevational side view of several alternatives for designs of the side-piece and glide of the rake of this invention.

FIG. 19 is a side elevational view showing the rake hung on a wall using a conventional implement hanger.

FIG. 20 is a side elevational view showing the rake hung on a wall using a nail.

FIG. 21 is a horizontal cross-sectional view of a type of implement hanger which may be used to hang the rake or broom of this invention.

FIG. 22 is a side elevational view of the broom of this invention.

FIG. 23 is a plan view of the broom head.

FIG. 24 is an exploded elevational perspective view showing the handle holder, adapter, and the distal portion of the handle.

FIG. 25 is a side elevational view of the broom head showing the wheel plate holder and the handle adapter.

FIG. 26 is an elevational perspective view of the wheel plate holder.

FIG. 27 is a side elevational view of the pin assembly for the wheel plate holder.

FIG. 28 is a front elevational view of the pin assembly for the wheel plate holder.

FIG. 29 is a plan view of the front portion of a wheel plate inserted in a wheel plate holder.

FIG. 30 is a plan view of the front portion of a wheel plate.

FIG. 31 is a side elevational view of a wheel attached to a wheel plate.

FIG. 32 is a side elevational view, partly in cut-away, of a swivel wheel attached to a wheel plate.

### DETAILED DESCRIPTION OF THE INVENTION

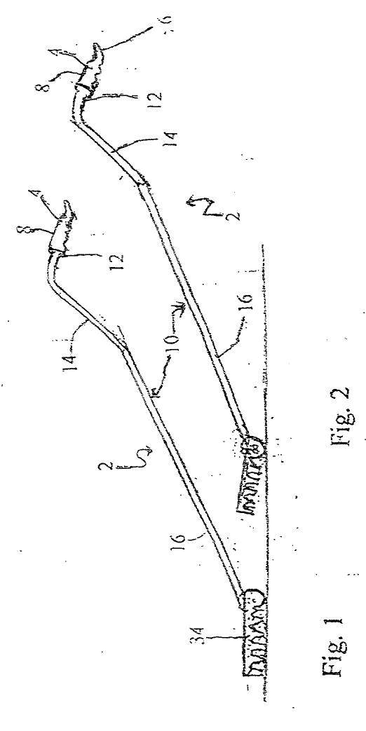

The rake 2 of the present invention presents several improvements not known to the prior art, each improvement designed to make the task of raking easier to the user. The rake 2, broadly, is shown in FIGS. 1 and 2. The rake 2 has a proximal handgrip 4 at the proximal end 6 which is attached to, and almost completely covers, the first, upwardly slanted, section 8 of the handle 10. The first section 8 of the handle 10 is bent to form a second, horizontal, section 12. The second section 12 is bent to become a steep downwardly slanted third section 14. The third section 14 is bent upward to form a fourth, straight, gradually downwardly slanted, section 16 of the handle 10. The fourth section 16 attaches at its distal end 18 to the rake head 20.

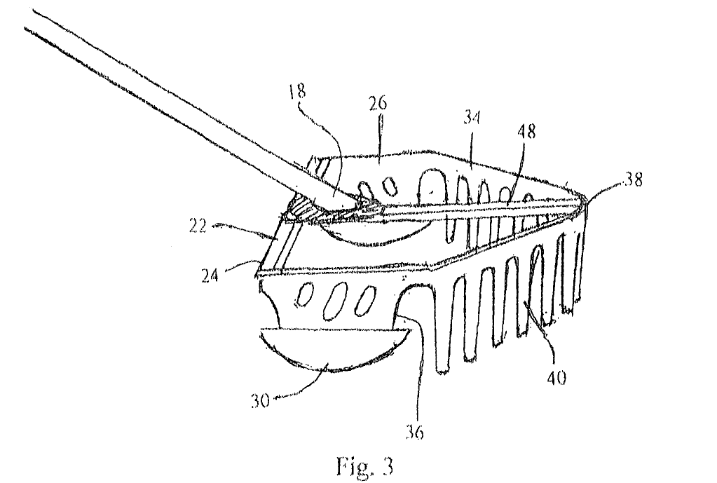

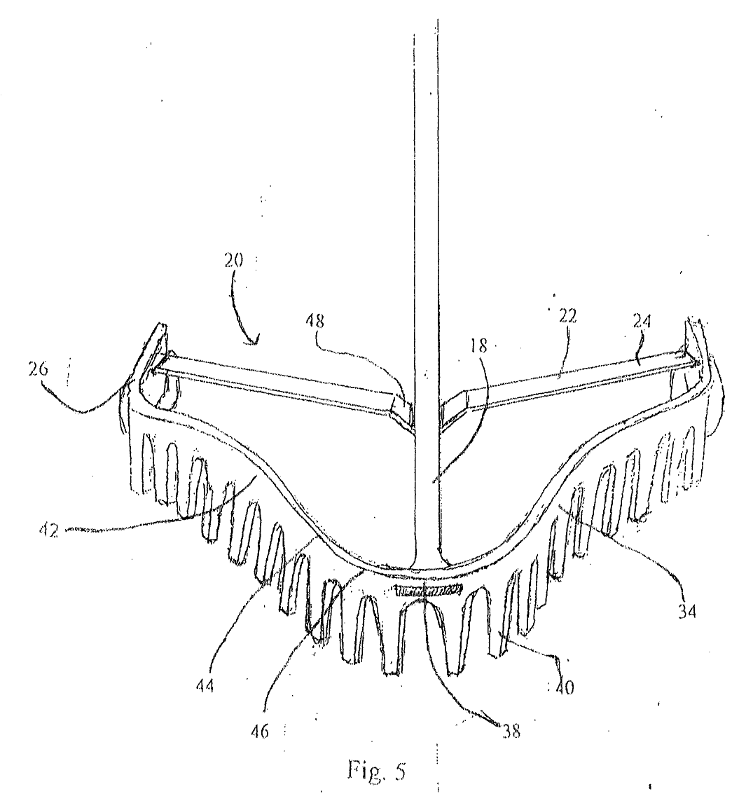

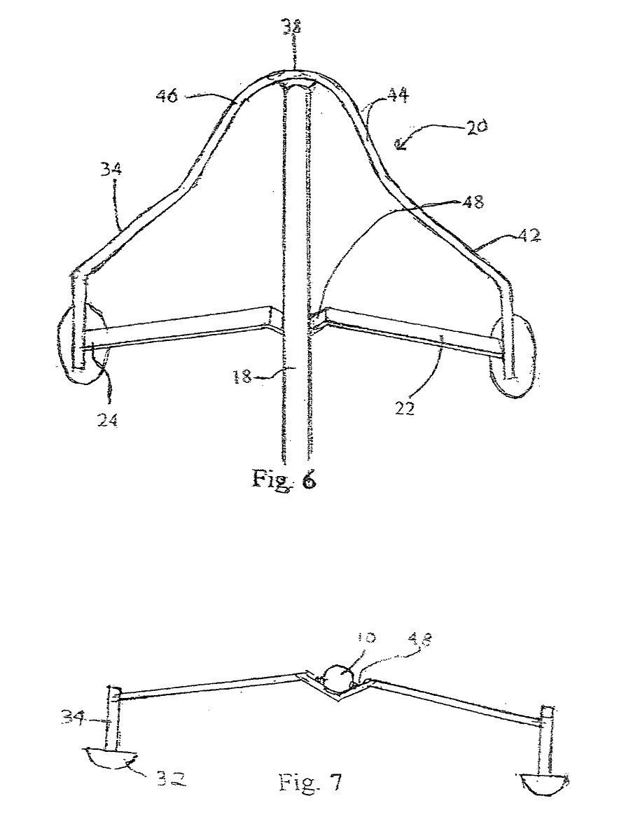

With reference to FIGS. 3-7 and 18, the rake head 20 will be described. A rear crossbar 22 having two ends 24 is attached at each end 24 to a sidepiece 26 of the rake head 20. The sidepiece 26 may be no more than a frame but preferably it is substantially solid, as see FIG. 18. The sidepiece 26 may be rounded on the bottom 28 and cause the rake 2 to glide when it is pulled along the ground or, preferably, it fits into a glide ski 30 or a glide spoon 32 with the same effect. Reference is made once more to FIG. 18 for the various alternatives. When a glide ski 30 or glide spoon 32 is used, the glide ski 30 or glide spoon 32 is preferably welded to the sidepiece 26 although other forms of attachment, such as bolting, are acceptable.

In one embodiment as shown in FIG. 3, the frame 34 extends from the forward end 36 of each sidepiece 26 in a single arc meeting at the center 38 which is the forward extension of the frame 34. Extending downwardly from the frame 34 are the tines 40. The tines 40 may be the same as or similar to tines of conventional rakes. They are spaced apart the same distance as in conventional rakes. However, since the angle at which the tines 40 contact the debris is different from the angle in a conventional rake, the apparent spacing between the tines 40 is decreased and there is greater contact of the tines 40 with the debris as compared to conventional rakes. It is intended that the present rake 2 be substantially wider than rakes of the prior art. This greater width, coupled with the presence of the side pieces 26, allows the rake 2 of the present invention to transfer a substantially greater amount of debris.

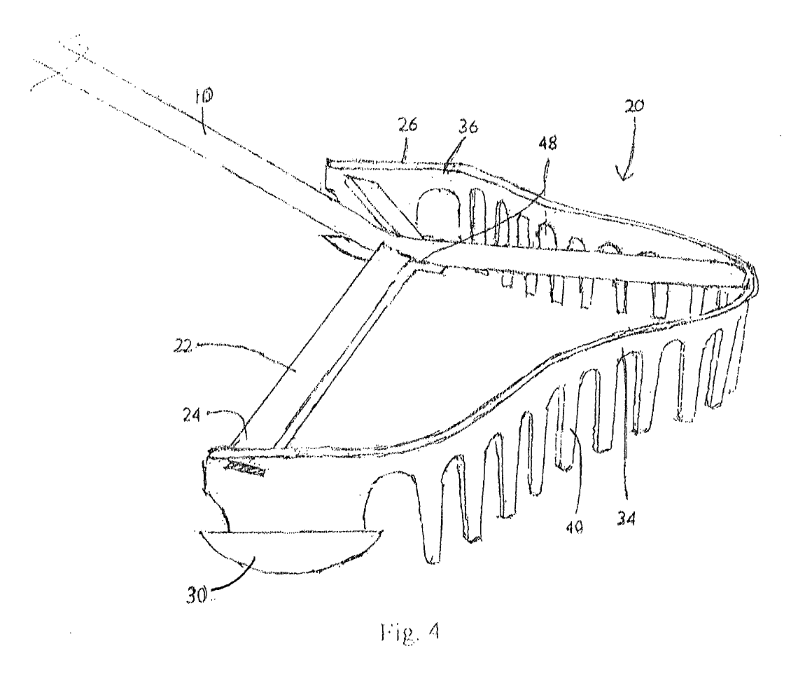

In a second, and preferred, embodiment as shown in FIGS. 4-7, the frame 34 extends from the forward end 36 of each sidepiece 26 in a gradual arc 42. About halfway to the center 38, the slope of the arc 42 becomes steeper 44 and changes again to become more gradual 46 near the center 38 so that the frame 34 reaches its greatest protrusion at the center 38 of the frame 34. Using this configuration, the rake 2 is able to contact the ground farther under shrubbery than can conventional rakes. As with the first embodiment, the tines 40 extend downwardly from the frame 34 and may be the same as or similar to tines 40 of conventional rakes. They are spaced apart the same distance as in conventional rakes. However, since the angle at which the tines 40 contact the debris is different from the angle in a conventional rake, the apparent spacing between the tines 40 is decreased and there is greater contact of the tines 40 with the debris as compared to conventional rakes.

The crossbar 22 contains a central notch 48 which holds the handle 10. The distal end 18 of the handle 10 attaches to the center 38 of the frame 34. This notch 48 helps to stabilize the handle 10.

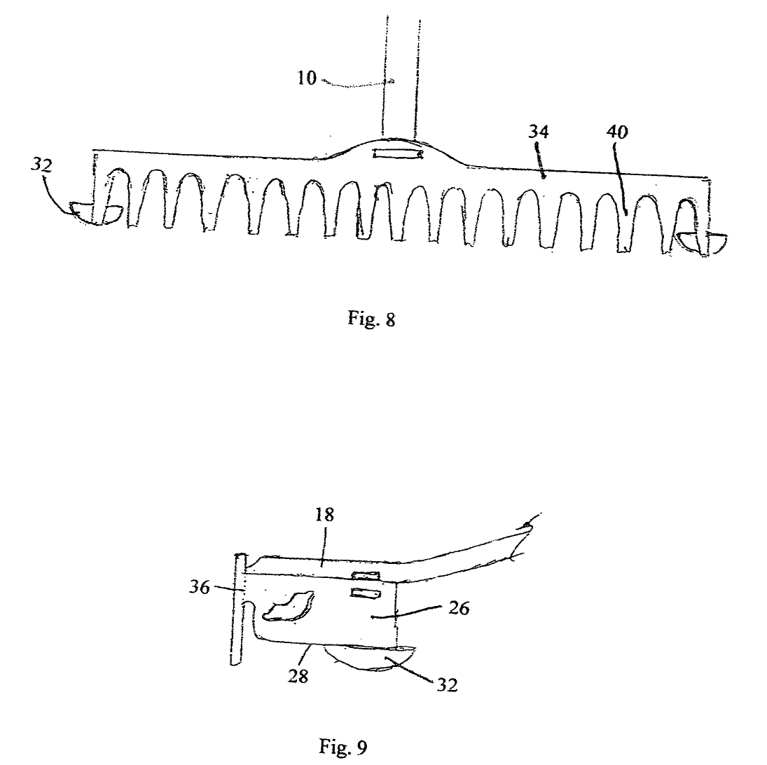

A third embodiment is disclosed in FIGS. 8-11. The rake head 20 is made up of a straight frame 34 which extends from one side to the other as in conventional rakes. On each side, a sidepiece 26 extends rearwardly from the frame 34. A crossbar 22 extends from one sidepiece 26 to the other behind the frame 34. The crossbar 22 contains a notch 48 in the center for supporting the distal end 18 of the handle 10 prior to its attachment to the frame 34. The bottom 28 of the sidepiece 26 may be rounded or a glide ski or glide spoon 32 may attached to the bottom 28 of the sidepieces 26. As in the above embodiments, a downward pressure on the handle 10 tilts the rake head 20 upwardly allowing the rake 2 to be repositioned without lifting.

As can be readily appreciated, in use the head 20 of the rake 2 is placed on the ground in the desired position, retracted toward the user, slid forward and to the side to another desired position, and retracted again. This operation does not involve lifting the rake head 20 off of the ground to change its position.

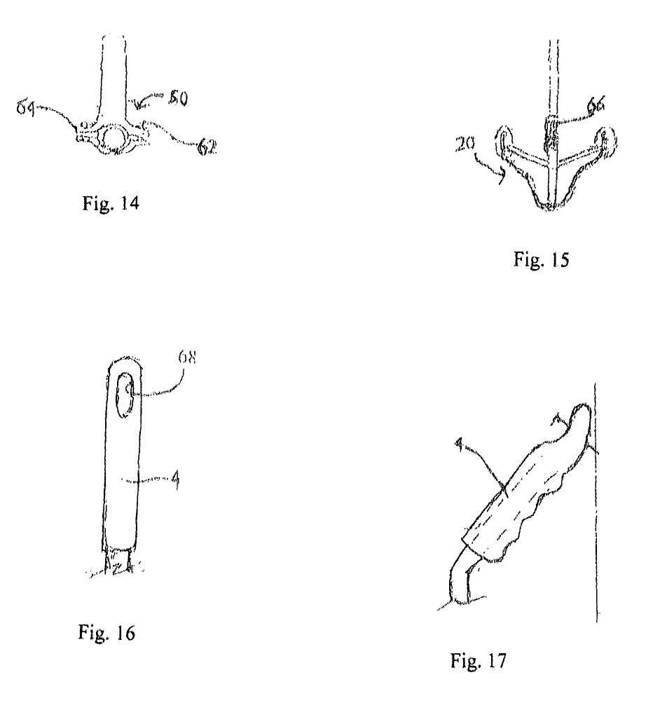

The handle 10 may be lengthened or shortened by using a connecting sleeve 50 as shown in FIG. 14. The connecting sleeve 50 is a clamp which fits around the proximal 52 and distal 54 sections of two adjacent sections of the handle 10. It may be fixedly attached to either section and moveably attached to the other section. For purposes of illustration, when the connecting sleeve 50 is fixedly attached to the proximal section 52, the distal section 54 may be moved proximally or distally and when the distal section 54 is in the desired position, the connecting sleeve 50 may be tightened. The connecting sleeve 50 contains two bolts 62 and two nuts for use in the wing portions 64 of the connecting sleeve 50 or two bolts 62 and threaded wing portions 64.

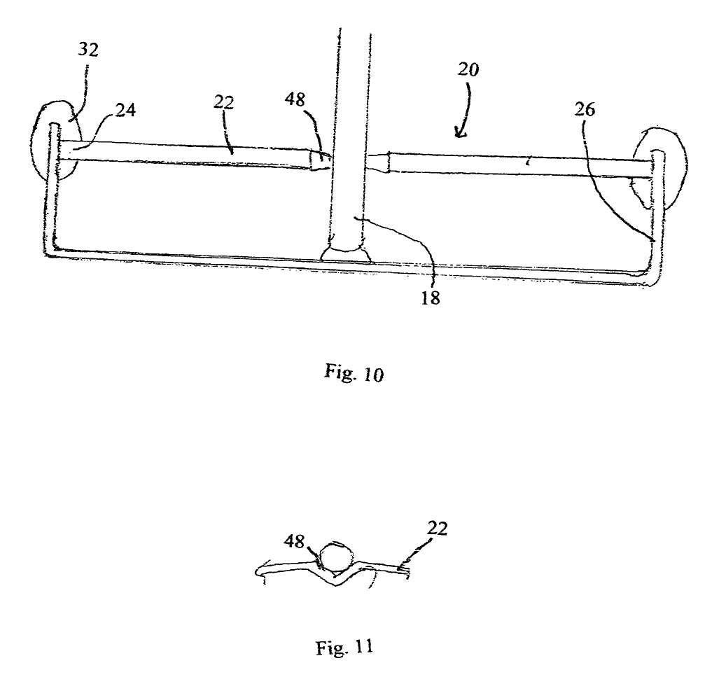

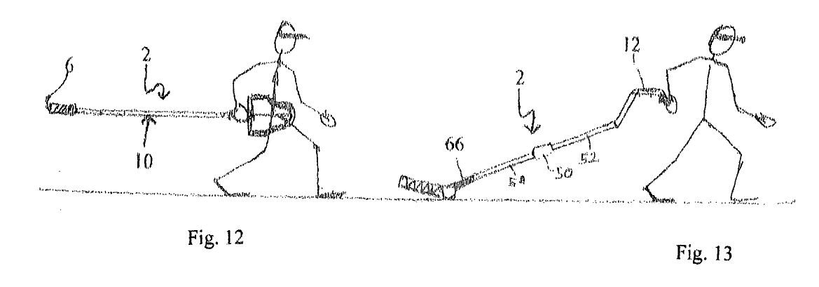

The center of gravity of the rake 2 of the present invention is immediately proximal to the rear of the head 20. Thus it may be easily carried as shown in FIG. 12 by holding it at that place or it may be easily dragged along the ground as shown in FIG. 13. For holding the rake 2, a distal handgrip 66 as shown in FIG. 15 is provided.

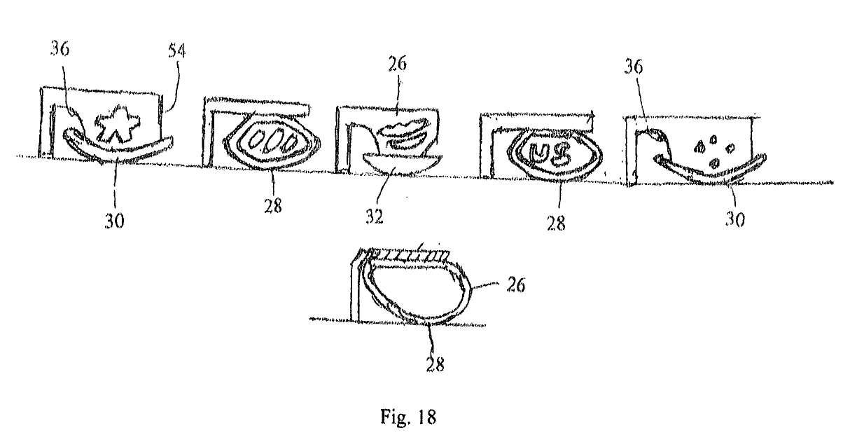

The rake 2 of the present invention may be easily stored by virtue of a proximal handgrip 4. As seen in FIGS. 16 and 17, the handle 10 contains a hole 68 in the proximal handgrip 4 so that the hole 68 may be placed over a nail driven into the wall. When this is done the rake 2 fits close to the wall and the tines 40 are pointed toward the wall as shown in FIG. 20.

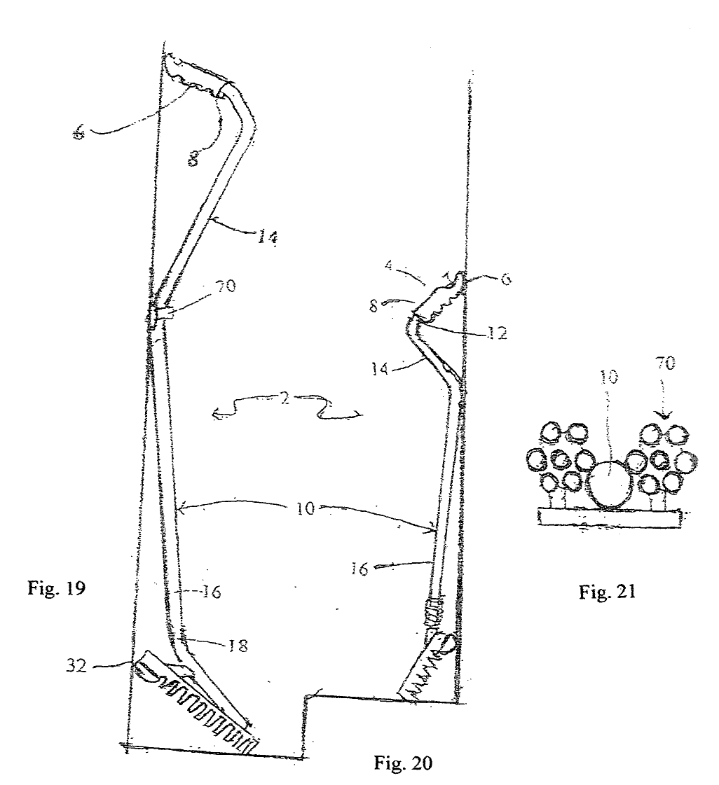

Alternatively, a common implement holder 70, such as a Crawford broom clip, as shown in FIG. 21 may be mounted on a wall and the rake 2 may be fitted into it at the bend between the third 14 and fourth 16 sections of the handle 10 as shown in FIG. 19.

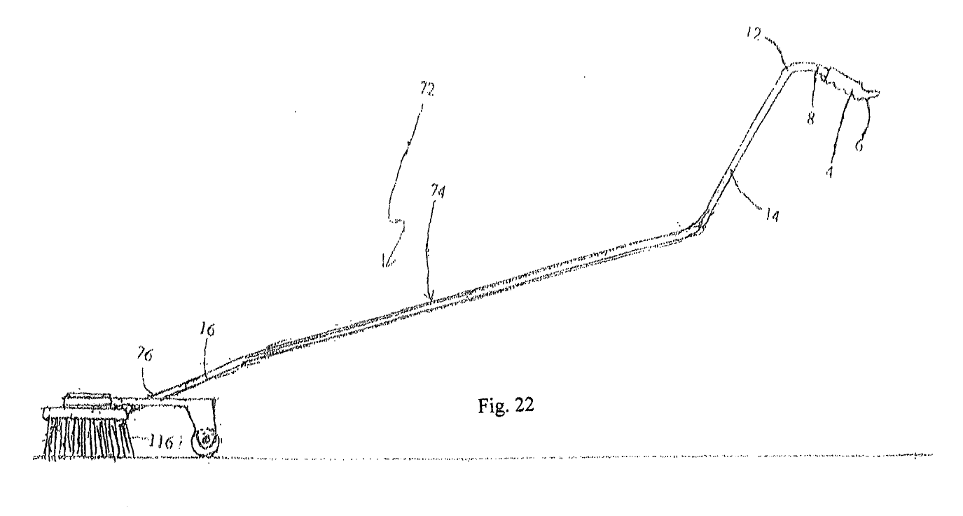

The implement for cleaning floors will now be discussed with reference to a push broom 72. The broom 72 of the present invention is viewed in FIG. 22. The broom handle 74 has a handgrip 4 at the proximal end 6 which is attached to, and almost completely covers, the first, upwardly slanted, section 8 of the handle 74. The first section 8 of the handle 74 is bent to form a second, horizontal, section 12. The second section 12 is bent to become a steep downwardly slanted third section 14. The third section 14 is bent upwardly to form a fourth, straight, gradually downwardly slanted, section 16 of the handle 74. The fourth section 16 attaches at its distal end 76 to an adapter 78 which is connected to the rectangular base 80 of the broom 72.

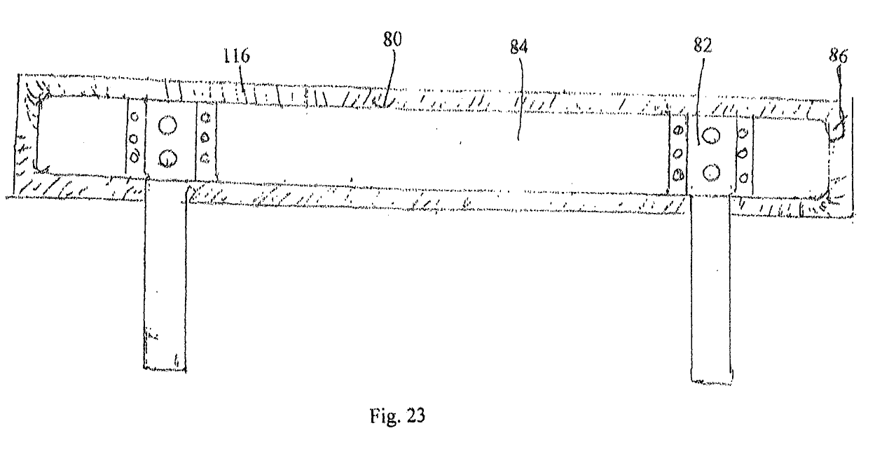

With reference to FIG. 23, it is seen that two wheel plate holders 82 are mounted on the top surface 84 of the broom base 80. The two wheel plate holders 82 are equidistant from the side ends 86 of the broom base 80. The handle holder 88 (not shown in FIG. 23) is located at the center of the top surface 84 of the broom base 80.

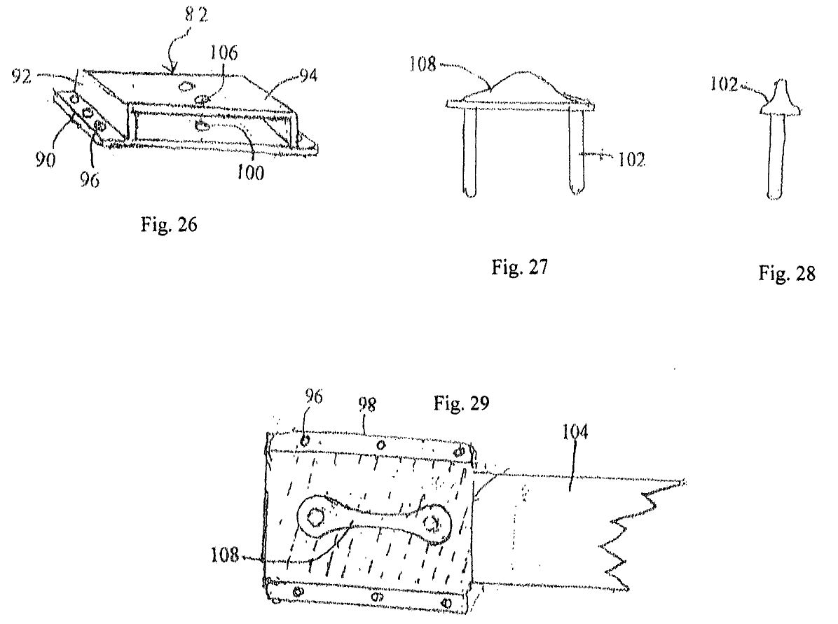

With reference to FIGS. 26-29, the wheel plate holder 82 is made up of a bottom piece 90, two side pieces 92 and a top piece 94. The bottom piece 90 has a plurality of connector holes 96 at each end 98 thereof for connecting to the top surface 84 of the base 80 with screws or bolts. The bottom piece 90 also contains a plurality of locking holes 100 located along the center line of the bottom piece 90 for holding the locking pins 102. The side pieces 92 extend upwardly from the bottom piece 90 medially from the connector holes 96. The side pieces 92 are of such a height as to allow easy, but snug, entrance of the wheel plate 104. The top piece 94 bridges the two side pieces 92 and contains a plurality of holes 106 equidistant from the side pieces. Thus, in use, the wheel plate holder 82 is an open slot firmly affixed to the top surface 84 of the broom base 80 and is of such size as to allow the snug fit of the wheel plate 104.

A pin holder 108 fits on the top piece 94 of the wheel plate holder 82 and holds a plurality, preferably two, locking pins 102. The locking pins 102 pass through the top piece 94 of the wheel plate holder 82 and the wheel plate 104 and into the bottom piece 90 of the wheel plate holder 82. As an option, the locking pins 102 may pass through the bottom piece 90 and into the broom base 80. As another, but less desired, alternative, the locking pins 102 may be presented without the pin holder 108. This alternative is just as effective, but allows for the loss of loose pins 102.

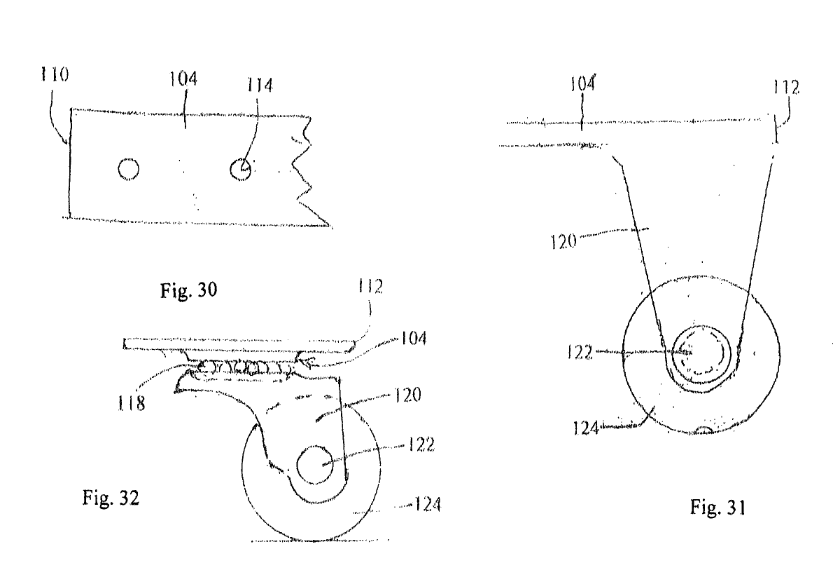

The wheel plate 104, as seen in FIGS. 30-32, has a free front end 110 and a free rear end 112. The free front end 110 contains holes 114 which are complimentary to the holes 100, 106 in the top 94 and bottom piece 90 of the wheel plate holder 82. Thus the wheel plate 104 may be firmly held in place by the locking pins 102. The wheel plate 104 may be used on either side of the broom base 80, thus permitting even wear of the bristles 116.

The free rear 112 end of the wheel plate 104 may be a swivel wheel shown in FIG. 32 which comprises ball bearings 118, a wheel holder 120, an axle 122, and a wheel 124. the ball bearings 118 allow free movement between the wheel plate 104 and the wheel holder 120. The broom 72 preferably features fixed wheel holders 120 shown in FIG. 31. By use of the wheel plate holder 82, the wheel plate 104, and the wheel 124, the operator may apply downward pressure on the broom handle 74 and the broom base 80 is lifted free from the surface being cleaned. This allows the rolling of the broom 72 to a new position for a new cleaning operation and avoids the lifting step common to prior art brooms.

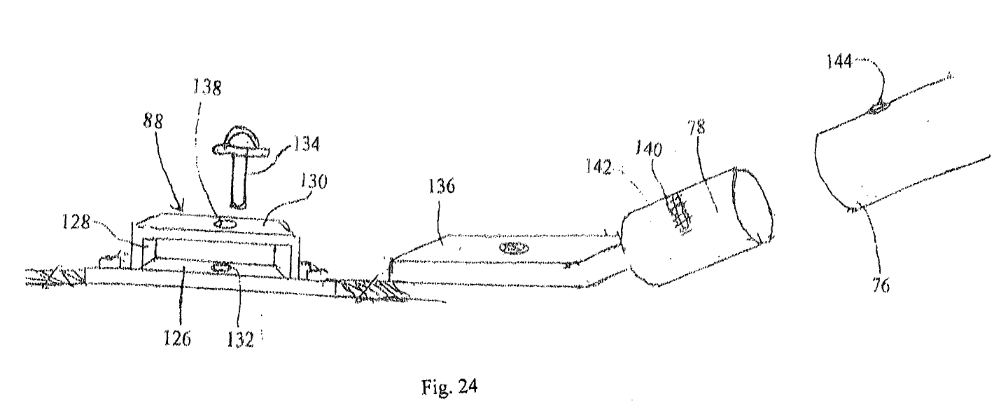

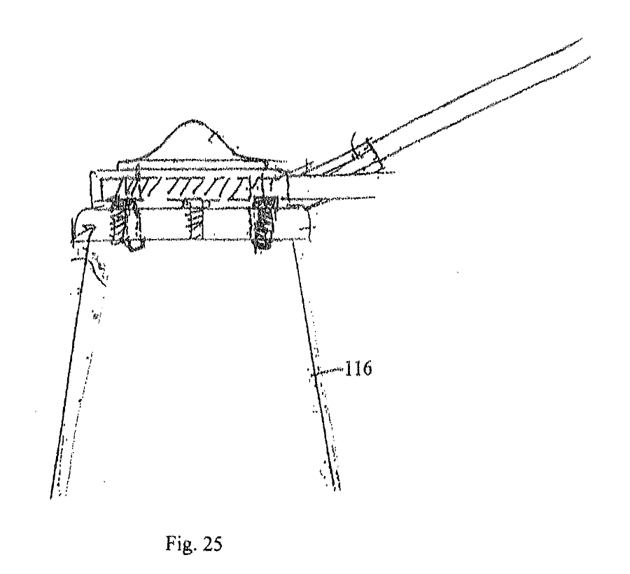

With reference to FIG. 24, the connection of the broom handle 74 to the broom base 80 will be described. The broom handle holder 88 is situated at the center of the top surface 84 of the broom base 80. The broom handle holder 88 is made up of a bottom piece 126, two side pieces 128 and a top piece 130. The bottom piece 126 has at least one connector hole (not shown) at each end thereof for connecting to the top surface 84 of the broom base 80 with screws or bolts. The bottom piece 126 also contains at least one locking hole 132 located along the center line of the bottom piece 126 for holding the locking pin(s) 134. The side pieces 128 extend upwardly from the bottom piece 126 medially from the connector holes. The side pieces 128 are of such a height as to allow easy, but snug, entrance of the handle connector plate 136. The top piece 130 bridges the two side pieces 128 and contains at least one hole 138 equidistant from the side pieces 128. Thus, in use, the handle holder 88 is an open slot firmly affixed to the top surface 84 of the broom base 80 and is of such size as to allow the snug fit of the handle connector plate 136.

A locking pin 134 fits on top of the handle holder 88 and passes through the top piece 130 of the handle holder 88 and the handle connector plate 136 and into the bottom piece 126 of the broom handle holder 88. As an option, the locking pin 134 may pass through the bottom piece 126 and into the broom base 80.

The handle connector plate 136, like the wheel plate 104, fits into either side of the broom base 80, allowing for even wear of the bristles 116. The proximal end of the handle connector plate 136 contains an upward angle and is attached to an adapter 78. The adapter 78 is preferably solid, but may be hollow. The adapter 78 contains a screw hole 140 in its upper surface 142. The hollow handle 74 fits over the top of the adapter 78 and fastens thereto with a screw passing through the screw hole 144 on the handle 74 and the screw hole 140 in the adapter 78. The features of the preferred broom handle 74 are like those described for the preferred handle 10 of the above-described rake 2.

Although the invention has been described and illustrated in detail, it is to be clearly understood that the same is by way of illustration and example, and is not to be taken by way of limitation. The spirit and scope of the present invention are to be limited only by the terms of the appended claims.

1. A rake having a handle having a proximal end and a distal end and a rake head having a front; a rear; two sidepieces which have front ends and bottom surfaces, an arced frame connecting the front ends of the side pieces wherein the fame extends from the forward end of each sidepiece in a gradual arc, about halfway between the forward end of each sidepiece and the center of the frame, the slope of the arc becomes steeper and changes again to become more gradual near the center of the frame so that the frame reaches its greatest forward protrusion at the center of the frame, and spaced-apart tines extending downwardly from the frame so that a downward pressure on the handle tilts the rake head upwardly about the bottom surfaces of the side pieces which serve as fulcrums resting upon the ground, allowing the rake to be repositioned without lifting by gliding the bottom surfaces of the side pieces along the ground.

2. The rake of claim 1, wherein the bottom surfaces of the sidepieces are so shaped as to be easily dragged along the ground.

3. The rake of claim 1, wherein the bottom surfaces of the sidepieces fit into glide skis.

4. The rake of claim 1, wherein the bottom surfaces of the sidepieces fit into glide spoons.

5-7. (canceled)

8. The rake of claim 1, wherein the handle is attached to a rear crossbar having two ends and which is attached at each end to a sidepiece of the rake head

9. The rake of claim 8, wherein the crossbar has a notch which receives the handle.

10. The rake of claim 1, wherein the handle has a first, upwardly slanted, section; the first section of the handle is bent to form a second, horizontal, section; the second section is bent to become a steep downwardly slanted third section; and the third section is bent upward to form a fourth, straight gradually downwardly slanted section of the handle attached to the rake head.

11. The rake of claim 10, wherein there is a distal handle grip immediately proximal to the rear of the rake head.

12. The rake of claim 10, wherein the straight portion of the handle has adjacent sections which are held in place by a connecting sleeve so as to enable the lengthening or shortening of the handle.

13-20. (canceled)

21. A rake having a handle having a proximal end and a distal end and a rake head having a front; a rear; two sidepieces which have front ends and bottom surfaces, an arced frame connecting the front ends of the side pieces wherein the frame extends forwardly from the forward end of each sidepiece in an arc so that the frame reaches its greatest forward protrusion at the center of the frame, and spaced-apart tines extending downwardly from the frame so that a downward pressure on the handle tilts the rake head upwardly about the bottom surfaces of the side pieces which serve as fularums resting upon the ground, allowing the rake to be repositioned without lifting by gliding the bottom surfaces of the side pieces along the ground and wherein the bottom surfaces of the sidepieces fit into glide skis or glide spoons.

22. (canceled)

23. A rake having a handle having a proximal end and a distal end and a rake head having a front; a rear; two sidepieces which have front ends and bottom surfaces, an arced frame connecting the front ends of the side pieces wherein the frame extends from the forward end of each sidepiece in a gradual arc, about halfway between the forward end of each sidepiece and the center of the frame, the slope of the arc becomes steeper and changes again to become more gradual near the center of the frame so that the frame reaches its greatest forward protrusion at the center of the frame, and spaced-apart tines extending downwardly from the frame so that a downward pressure on the handle tilts the rake head upwardly about the bottom surfaces of the side pieces which serve as fulcrums resting upon the ground, allowing the rake to be repositioned without lifting by gliding the bottom surfaces of the side pieces along the ground and wherein the bottom surfaces of the sidepieces fit into glide skis or glide spoons.
